(19) United States
(12) Patent Application Publication
(10) Pub. No.: US 2009/0291580 A1
(43) Pub. Date: Nov. 26, 2009

(54) Seal member for coaxial cable connector and terminal

(76) Inventors: Donald Andrew Burris, Peoria, AZ (US); William Bernard Lutz, Glendale, AZ (US)

Correspondence Address: CORNING INCORPORATED, SP-TI-3-1, CORNING, NY, 14831, US

(21) Appl. No.: 12/154,126

(22) Filed: May 20, 2008

(51) Int. Cl. H01R 13/62

(52) U.S. Cl. 439/320

(57) ABSTRACT

A seal member for a coaxial cable connector has a generally tubular seal body with a first and s first and second positions. The seal member also includes a retaining member to hold the seal member on a connector. The seal member has an internal surface that in one position is directed at least in part radially outward. The seal member may also have a first outer surface that touches the retaining member in one of the positions.

### BACKGROUND OF THE INVENTION

1. Field of the Invention

The present invention relates generally to seals for coaxial cable connectors, and particularly to seals for sealing gaps at interfaces between coaxial cable connectors and terminals.

2. Technical Background

Coaxial cable connectors such as F-connectors are used to attach a coaxial cable to another object such as an appliance or junction having a terminal adapted to engage the coaxial cable connector. When used outdoors in weather-exposed areas it is desirable to prevent moisture from entering the terminal/connector/cable system. Various connectors are commercially available for outdoor applications and generally prevent moisture from entering the connector/cable junction. Such connectors must be attached to a coaxial cable using various cable preparation techniques and installation tools. Cable preparation typically requires removal of a portion of the cable jacket, braid, outer conductor and core to expose the cable center conductor. Another portion of the cable jacket is removed to expose the cable braid. Cable preparation is often completed by folding of the cable braid structure back against the remaining cable jacket. The cable is then inserted into the connector, after which the connector is activated to secure the connector to the coaxial cable. For outdoor applications the connector is generally sealed to the cable either by the internal workings of the connector or by the use of an external sealant, heat shrinkable tubing, rubber cement, fusing tape or rubberized boot.

In order to maintain the integrity of the coaxial system, moisture must be prevented from entering the connector/appliance junction as well. In the past, others have attempted to provide a connector/appliance seal by using a rubber type material in the form of a tight fitting ring with an inner bore and an outer diameter or shape. For various reasons, the foregoing attempts have yielded less than satisfactory results. For example, attempts at encapsulating the connectors with tapes, shrink wrappings and plastic or rubber cements are too prone to installation errors, resulting in exposed seams and/or internal voids where moisture can collect and eventually penetrate to the cable junction. Moreover, shrink wrappings require the use of heat or chemicals which further complicate installation procedures. Cements require time to set up and cure, thus also prolonging and complicating installation procedures. The use of sealing components such as externally applied flexible boots and/or grommets again results in internal voids where moisture can collect. Installation of tight fitting seal rings is difficult and therefore many times is avoided. Subsequent removal of tight fitting seal rings after a lengthy period of service can be even more difficult than installation and oftentimes requires the use of a knife or similar instrument to cut the seal ring off of the appliance junction. This can likely result in damage to the junction threads and is not desirable. Additionally, existing seal rings are limited in use by the length of terminal port on which they are installed. A specific length seal ring must be matched with and installed on a terminal port of compatible length, thereby requiring the technician to recognize various port lengths and have a correct assortment of seal rings on hand. Examples of known seals are illustrated in FIGS. 1 & 2. As illustrated, a seal ring 10 typically has an outer surface 12 and an internal surface 14 that engages the seal 16 after it is placed on nut component 20. While this arrangement seals the connector 22, it prevents a user from being able to see the threads on the connector so that they can be mated to a terminal and does not allow access to the center conductor of the connector, preventing the user from trimming or being able to align the conductor with an appropriate receptacle. With the seal 16 extending away from the connector 22, it would engage the terminal before the nut component, making the coupler rotation difficult.

It would be desirable therefore to provide a terminal/connector junction sealing device that allow the user to view the connector nut of the connector and the center conductor during installation and provide resistance to coupler rotation only after the installation is complete.

### SUMMARY OF THE INVENTION

Disclosed herein is a flip-down seal member for use with a coaxial cable connector and a terminal, the flip-down seal member includes a generally tubular seal body having a first section having a first outer surface and a second section having a second outer surface, the first section being in a first position wherein at least a portion of the first outer surface is positioned circumferentially around the second outer surface of the second section and wherein the first section is capable of being flipped away from the second section to a second position, a retaining member, the retaining member configured to engage the outer surface of the second section to hold the generally tubular seal body on a coaxial cable connector.

In some embodiments, the first inner surface of the first section does not contact the first outer surface in the first position.

In some embodiments, the retaining member engages both the first and the second outer surfaces in the first position.

In some embodiments, the seal body has a hinge portion disposed between the first and second sections and in other embodiments the seal body has a flexure region.

In another aspect, a flip-down seal member for use with a coaxial cable connector and a terminal, the flip-down seal member includes a generally tubular seal body having a first section and a second section, the first section having a first outer surface and a first inner surface, and the second section having a second outer surface, a retaining member, the retaining member configured to engage the second outer surface of the second section to hold the generally tubular seal body on a coaxial cable connector, wherein, in a first position, the first inner surface and the second outer surface face radially outwardly, and wherein, in a second position, first outer surface and the second outer surface face radially outward.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 illustrates a perspective view of a prior art seal installed on a connector;

FIG. 2 is an exploded view of a portion of a connector with a prior art seal;

FIG. 3 is a partial cutaway view of one embodiment of a flip-down seal according to the present invention on a coaxial cable connector in a first position;

FIG. 4 is a partial cutaway view of the flip-down seal of FIG. 3 in a second position;

FIG. 5 is an elevational view of the flip-down seal of FIG. 3;

FIG. 6 is a partial cutaway view of the flip-down seal of FIG. 3 on a connector with a coaxial cable fully installed;

FIG. 7 is a partial side cutaway view of the flip-down seal of FIGS. 3-6 with the coaxial cable connector installed on a terminal;

FIG. 8A is an elevational view of a second embodiment of a flip-down seal according to the present invention on a coupling nut in a first position;

FIG. 8B is a cutaway view of the flip-down seal of FIG. 8A; and

FIG. 8C is a cutaway view of the flip-down seal of FIG. 8A in the second position;

FIG. 9 is a partial cutaway view of another embodiment of a flip-down seal according to the present invention on a connector nut in a first position; and

FIG. 10 is a partial cutaway view of another embodiment of a flip-down seal according to the present invention on a coupling nut in a first position.

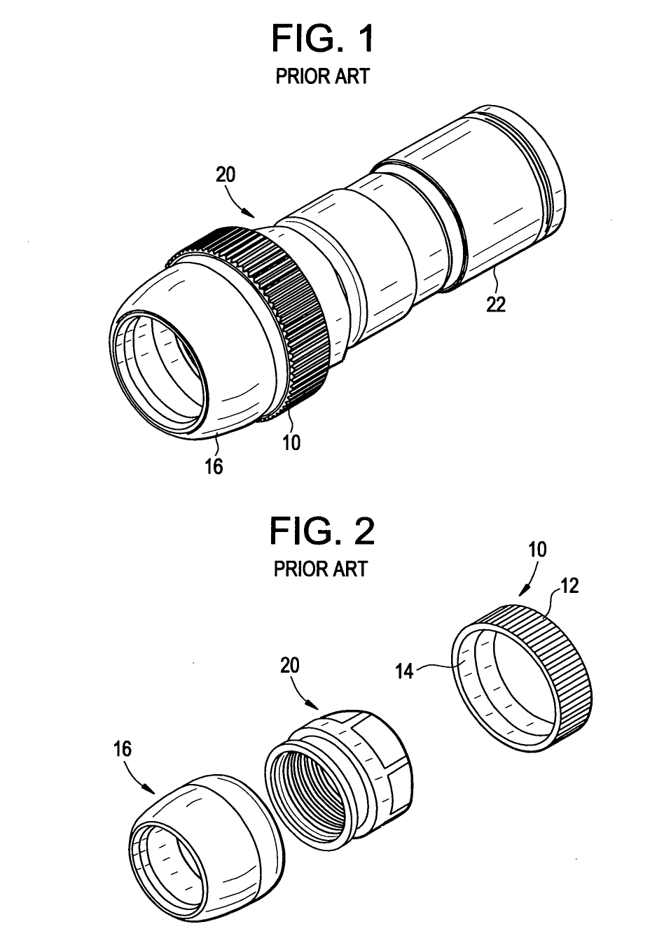

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

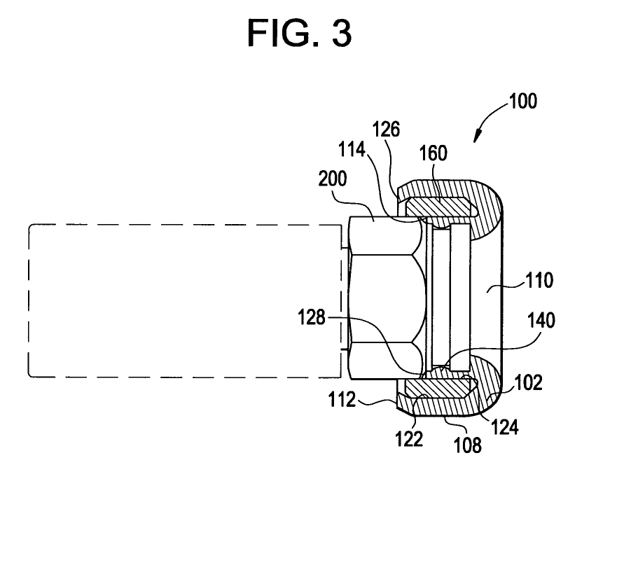

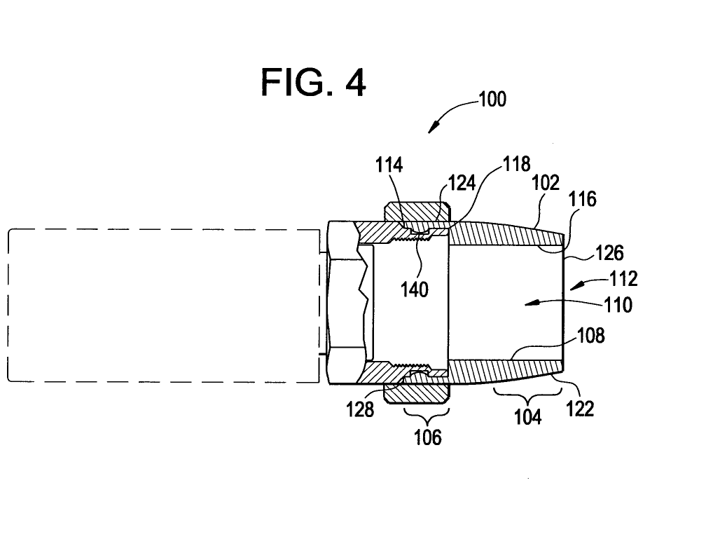

Referring to FIGS. 3 & 4, the flip-down seal member 100 comprises a generally tubular seal body 102 that has a first section 104 and a second section 106. The flip-down seal member 100 is illustrated in a first position in FIG. 3, which is the position for shipping of the connector from the factory, while the flip-down seal member 100 is in a second position in FIG. 4, which is the position after the connector has been installed on a corresponding connector, usually a terminal (not shown). The seal body 102 has an internal surface 108 defining an opening 110 between a first end 112 and a second end 114. By generally tubular, we mean that the internal surface 108 and/or the external surface of the seal body can have one or a plurality of diameters and/or cross-sectional shapes. The first section 104 of seal body 102 has a first outer surface 122 and the second section 106 of seal body 102 has a second outer surface 124. The first end 112 has a first axial end surface 126 and second end 114 has a second axial end surface 128. The first section 104 of seal body 102 has a first inner surface 116 and the second section 106 of seal body 102 has a second inner surface 118.

The seal member 100 is illustrated in FIG. 3 as being in a first position. That is, the seal member 100 will remain as illustrated in FIG. 3 unless it is acted upon by some outside force, i.e., a user or an installer. In this first position, first section 104 and the second section 106 are generally parallel to one another, but in separate planes. The first section 104 generally lies in plane A, outwardly of plane B, which is the plane for the second section 106. In this first position, the first and second outer surfaces 122, 124 face radially toward one another, with the first inner surface 116 facing radially outward. The second inner surface 118 engages the outer surface of the coupling nut 200. As illustrated in FIG. 3, the first section 104 covers the second section 106 in the first position. The seal member 100 is preferably molded from a silicone material rather than materials such as EPDM, vinyl, or a like material, which stretch or set in a certain position.

The opening 110 at second end 114 is preferably slightly smaller than the coupling nut 200 on which it is to be installed. As illustrated in FIG. 3, the second end 114 will engage the coupling nut 200, while first end 112 will engage a terminal. Similarly, the diameter of the opening 110 adjacent first end 112 is preferably smaller than an outermost diameter of the terminal. The flip-down seal member 100 is preferably thicker at the first section 104 than at the second section 106.

The flip-down seal member 100 also includes a retaining member 160, which is preferably made of brass, and is preferably press fit over the generally tubular seal body 102 onto a connector, and more particularly, a coupling nut 200. The retaining member 160 engages the second outer surface 124 of the second section 106. In the first position, the first outer surface 122 of the first section 104 engages the retaining member 160 rather than the second outer surface 124 of the second section.

In a preferred embodiment, the seal body 102 preferably has an inwardly projecting rib 140 disposed on the second inner surface 118 of the section 106. The inwardly projecting rib 140 engages a circumferential groove in the coupling nut 200 to assist with the retention of the seal body 102 on the coupling nut 200, although the inwardly projecting rib 140 is not necessary.

It should be noted that the type/configuration/style of body of the connector attached to coupling nut 200 is not critical. As indicated in the figures, the connector body may be of any configuration and operation and be within the scope of the present invention.

As illustrated in FIG. 4, when the flip-down seal member 100 is in the second position, the first section 104 and the second section 106 are generally in the same plane, plane B. The second position is the position for the flip-down seal member 100 after the connector has been connected to the terminal (not shown).

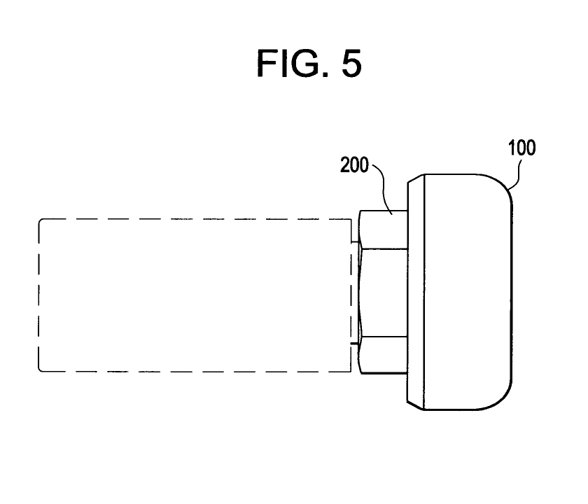

FIG. 5 is a plane view of the flip-down seal member 100 in the first position. It can be seen that regular installation tools can still be used with the connector even with the flip-down seal member 100 installed on the coupling nut 200.

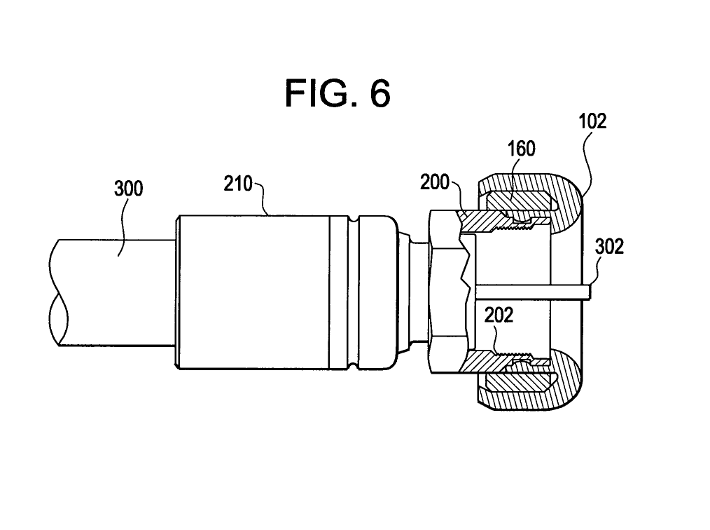

FIG. 6 illustrates the flip-down seal member 100 after a coaxial cable 300 has been installed into a connector 210 attached to the coupling nut 200. The center conductor 302 of the coaxial cable 300 preferably extends beyond the end of the flip-down seal member 100 when it is flipped back into the first position. This allows the user to see the center conductor 302 of the coaxial cable (as well as the threads 202 of the coupling nut 200) to assist in securing the connector 210 onto the terminal or other connector (not shown). The flip-down seal member 100 also provides improved finger griping for rotating (and indeed even grasping the coupling nut 200) when installing the connector 210.

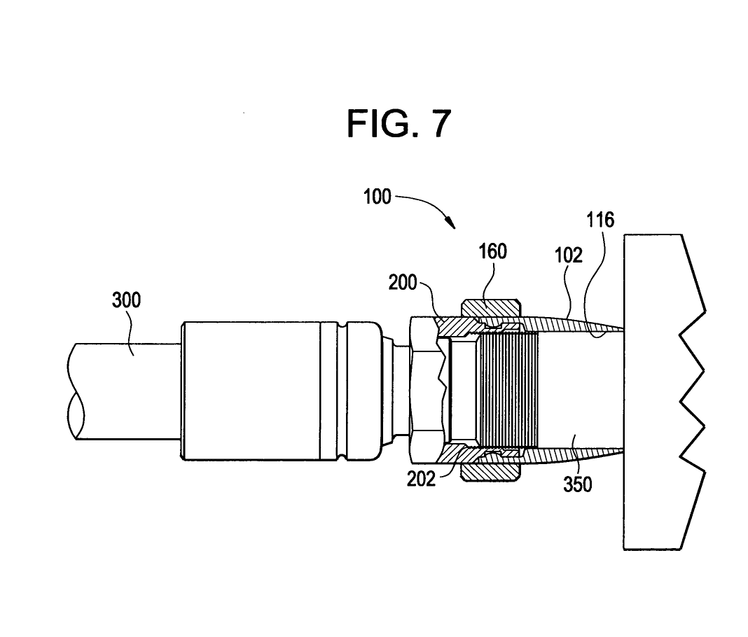

The connector 210 is illustrated as having been installed on a terminal 350 in FIG. 7. The coupling nut 200 has been rotated to engage the threaded portion of the terminal 350, and the flip-down seal member 100 has been flipped from the first position to the second position. In the second position, the first inner surface 116 engages the terminal 350, to seal the junction.

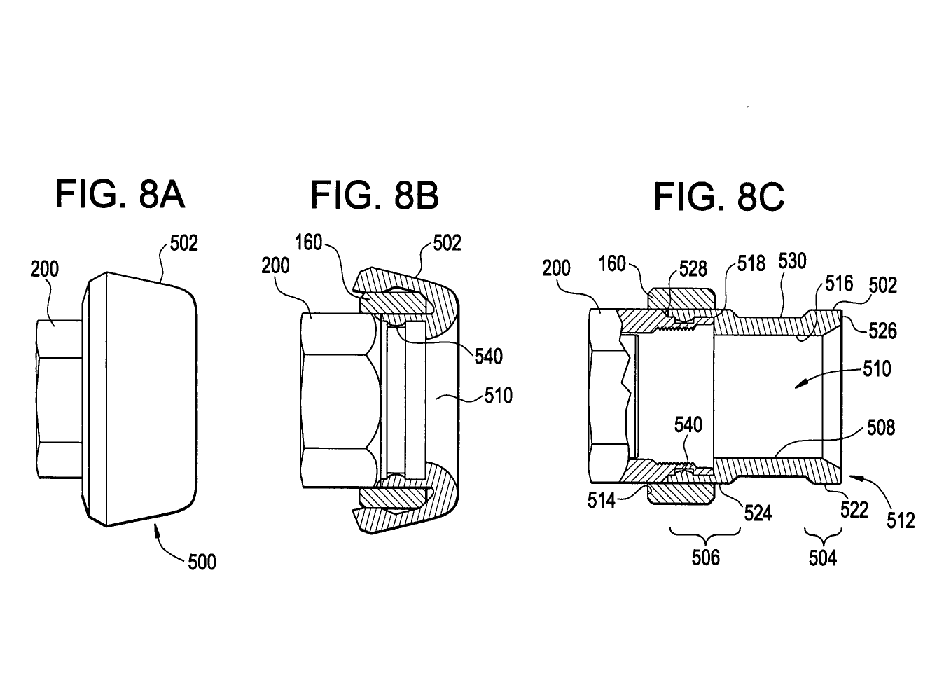

Another embodiment of a flip-down seal member 500 is illustrated in FIGS. 8A-8C. FIG. 8A illustrates in an elevational view, the flip-down seal member 500 attached to a coupling nut 200 in a first position. FIG. 8B illustrates that the flip-down seal member 500 also comprises a generally tubular seal body 502 that has a first section 504 and a second section 506. The seal body 502 has an internal surface 508 defining an opening 510 between a first end 512 and a second end 514. By generally tubular, we mean that the internal surface 508 and/or the external surface of the seal body can have one or a plurality of diameters and/or cross-sectional shapes. The first section 504 of seal body 502 has a first outer surface 522 and the second section 506 of seal body 502 has a second outer surface 524. The first end 512 has a first axial end surface 526 and second end 514 has a second axial end surface 528. The first section 504 of seal body 502 has a first inner surface 516 and the second section 506 of seal body 502 has a second inner surface 518.

The seal body 502 preferably has a hinge portion 530 disposed between the first section 504 and the second section 506. The hinge portion 530 preferably has a reduced tubular wall thickness preferably with an outer diameter that is smaller than the outer diameter of the seal body 502 at both the first and second ends 512, 514.

In a preferred embodiment, the seal body 502 preferably has an inwardly projecting rib 540 disposed on the second inner surface 518 of the section 506. The inwardly projecting rib 540 engages a circumferential groove in the coupling nut 200 to assist with the retention of the seal body 502 on the coupling nut 200, although the inwardly projecting rib 540 is not necessary.

The flip-down seal member 500 also includes retaining member 160 and is press fit over the generally tubular seal body 502 onto a connector, and more particularly, a coupling nut 200. The retaining member 160 engages the second outer surface 524 of the second section 506. In the first position, the first outer surface 522 of the first section 504 engages the retaining member 160 rather than the second outer surface 524 of the second section.

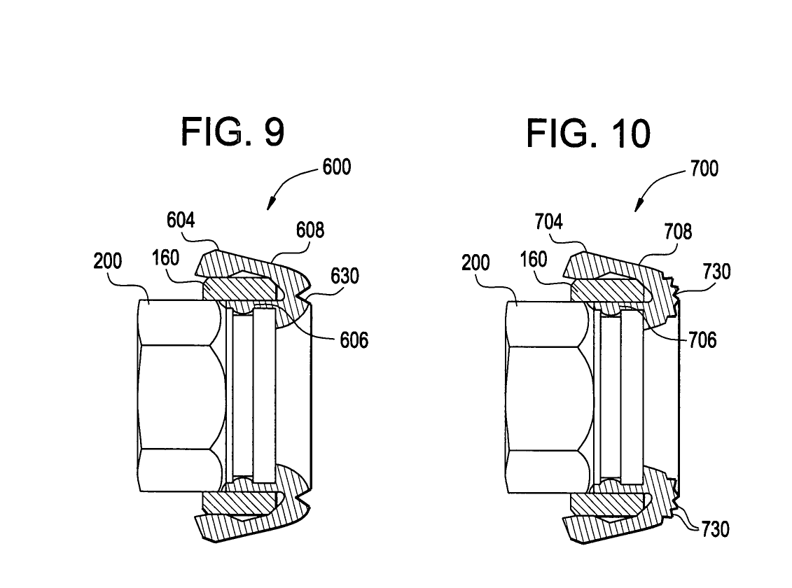

Another alternative embodiment of a flip-down seal member 600 is illustrated in FIG. 9. FIG. 9 illustrates the flip-down seal member 600 attached to a coupling nut 200 in a first position. FIG. 9 illustrates that the flip-down seal member 600 is very similar to the other embodiments of a flip-down seal member in that it also has a retaining member 160. However, the internal surface 608 has a groove 630 to assist with the flipping back of the first section 604 over the second section 606.

Another alternative embodiment of a flip-down seal member 700 is illustrated in FIG. 10. FIG. 10 illustrates the flip-down seal member 700 attached to a coupling nut 200 in a first position. FIG. 10 illustrates that the flip-down seal member 700 is very similar to the other embodiments of a flip-down seal member in that it also has a retaining member 160. However, the internal surface 708 has a plurality of grooves 730 to assist with the flipping back of the first section 704 over the second section 706.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A flip-down seal member for use with a coaxial cable connector and a terminal, the flip-down seal member comprising:
a generally tubular seal body comprising a first section having a first outer surface and a second section having a second outer surface, the first section being in a first position wherein at least a portion of the first outer surface is positioned circumferentially around the second outer surface of the second section and wherein the first section is capable of being flipped away from the second section to a second position; and
a retaining member, the retaining member configured to engage the outer surface of the second section to hold the generally tubular seal body on a coaxial cable connector.

2. The flip-down seal member of claim 1, wherein the first section has a first inner surface, and wherein the first inner surface does not contact the first outer surface in the first position.

3. The flip-down seal member of claim 1, wherein the first section comprises an increased tubular wall thickness region.

4. The flip-down seal member of claim 1, wherein, in the first position, the outer surface of the first section contacts the retaining member.

5. The flip-down seal member of claim 4, wherein the first section further comprises a first axial end surface and the second section further comprises a second axial end surface, wherein the first and second axial end surfaces do not contact each other in the first position, and wherein the first and second axial end surfaces do not contact each other in the second position.

6. The flip-down seal member of claim 1, wherein the first section, in the second position, is generally parallel to the second section and the first and second sections generally lie in a single plane.

7. The flip-down seal member of claim 1, wherein the seal body further comprises a hinge portion disposed between the first and second sections.

8. The flip-down seal member of claim 7, wherein the hinge portion comprises a reduced thickness tubular wall region.

9. The flip-down seal member of claim 7, wherein the hinge portion comprises an inner surface provided with a groove.

10. The flip-down seal member of claim 7, wherein the hinge portion comprises an inner surface provided with at least two grooves.

11. The flip-down seal member of claim 1, wherein the first section is separated from the second section in the first position by the retaining member in the first position.

12. The flip-down seal member of claim 1, wherein the second section has a second inner surface, and further comprising an inwardly projecting rib disposed on the second inner surface of the second section of the generally tubular seal body.

13. A flip-down seal member for use with a coaxial cable connector and a terminal, the flip-down seal member comprising:
a generally tubular seal body comprising a first section and a second section, the first section having a first outer surface and a first inner surface, and the second section having a second outer surface,
a retaining member, the retaining member configured to engage the second outer surface of the second section to hold the generally tubular seal body on a coaxial cable connector, wherein, in a first position, the first inner surface and the second outer surface face radially outwardly, and wherein, in a second position, first outer surface and the second outer surface face radially outward.

14. The flip-down seal member of claim 13, wherein the first inner surface does not contact the first outer surface in the first position.

15. The flip-down seal member of claim 13, wherein the first section comprises an increased tubular wall thickness region.

16. The flip-down seal member of claim 13, wherein, in the first position, all of the second outer surface is covered by the first section.

17. The flip-down seal member of claim 13, wherein the first section comprises an increased tubular wall thickness region.

18. The flip-down seal member of claim 13, wherein, in the first position, the outer surface of the first section contacts the retaining member.

19. The flip-down seal member of claim 18, wherein the first section further comprises a first axial end surface and the second section further comprises a second axial end surface, wherein the first and second axial end surfaces do not contact each other in the first position, and wherein the first and second axial end surfaces do not contact each other in the second position.

20. The flip-down seal member of claim 13, wherein the first section, in the second position, is generally parallel to the second section and the first and second sections generally lie in a single plane.

21. The flip-down seal member of claim 13, wherein the seal body further comprises a hinge portion disposed between the first and second sections.

22. The flip-down seal member of claim 21, wherein the hinge portion comprises a reduced thickness tubular wall region.

23. The flip-down seal member of claim 21, wherein the hinge portion comprises an inner surface provided with a groove.

24. The flip-down seal member of claim 21, wherein the hinge portion comprises an inner surface provided with at least two grooves.

25. The flip-down seal member of claim 13, wherein the first section is separated from the second section in the first position by the retaining member.
